(19) United States
(12) Patent Application Publication
(10) Pub. No.: US 2026/0370301 A1
(43) Pub. Date: Nov. 19, 2026

(54) O-RAN FRONTHAUL SIGNALING FOR UPLINK BEAMFORMING

(71) Applicant: Samsung Electronics Co., Ltd., Suwon-si (KR)

(72) Inventors: Xinliang Zhang, Plano, TX (US); Joonki Kim, Seoul (KR); Young Han Nam, Plano, TX (US); Min Jang, Suwon-si (KR)

(21) Appl. No.: 19/664,825

(22) Filed: Apr. 30, 2026

Related U.S. Application Data
(60) Provisional application No. 63/806,941, filed on May 16, 2025.

(51) Int. Cl. H04B 7/06; H04B 7/0426; H04B 7/0456

(52) U.S. Cl. CPC H04B 7/06952; H04B 7/043; H04B 7/0456; H04B 7/0639

(57) ABSTRACT

Methods and systems for O-RAN fronthaul signaling for uplink beamforming. A method includes enabling a diverse beamforming feature using a radio unit (RU) based on a diverse beamforming indication. The beamforming feature includes one or more beam identifiers (IDs). The method also includes receiving, at the RU, confirmation of the diverse beamforming feature being enabled from a distributed unit (DU). The method also includes configuring a plurality of uplink user plane (U-plane) ports such that each of the plurality of uplink U-plane ports having a different end point. The method also includes determining, using the RU, beamforming weights per uplink U-plane port. The method also includes applying, using the RU, the beamforming weights to the end point of the plurality of uplink U-plane ports to obtain a beamformed signal. The method also includes transmitting, using the RU, the beamformed signal to the DU.

### CROSS-REFERENCE TO RELATED APPLICATIONS AND CLAIM OF PRIORITY

The present application claims priority to U.S. Provisional Patent Application No. 63/806,941, filed on May 16, 2025. The contents of the above-identified patent documents are incorporated herein by reference.

### TECHNICAL FIELD

The present disclosure relates generally to wireless communication systems. more specifically, the present disclosure relates to a system and method for open radio access network (O-RAN) fronthaul signaling for uplink beamforming.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

### SUMMARY

The present disclosure relates generally to wireless communication systems and, more specifically, the present disclosure relates to a system and method for O-RAN fronthaul signaling for uplink beamforming.

In one embodiment, a method is provided. The method includes enabling a diverse beamforming feature using a radio unit (RU) based on a diverse beamforming indication. The beamforming feature includes one or more beam identifiers (IDs). The method also includes receiving, at the RU, confirmation of the diverse beamforming feature being enabled from a distributed unit (DU). The method also includes configuring a plurality of uplink user plane (U-plane) ports such that each of the plurality of uplink U-plane ports having a different end point. The method also includes determining, using the RU, beamforming weights per uplink U-plane port. The method also includes applying, using the RU, the beamforming weights to the end point of the plurality of uplink U-plane ports to obtain a beamformed signal. The method also includes transmitting, using the RU, the beamformed signal to the DU.

In another embodiment, an electronic device is provided. The electronic device includes a transceiver, and a processor operably coupled to the transceiver. The processor is configured to cause the electronic device to enable a diverse beamforming feature based on a diverse beamforming indication. The beamforming feature includes one or more beamIDs. The processor is also configured to cause the electronic device to receive confirmation of the diverse beamforming feature being enabled from a DU. The processor is also configured to cause the electronic device to configure a plurality of uplink U-plane ports such that each of the plurality of uplink U-plane ports has a different end point. The processor is also configured to cause the electronic device to determine beamforming weights per uplink U-plane port. The processor is also configured to cause the electronic device to apply the beamforming weights to the end point of the plurality of uplink U-plane ports to obtain a beamformed signal. The processor is also configured to cause the electronic device to transmit the beamformed signal to the DU.

In yet another embodiment, a non-transitory computer-readable medium is provided. The non-transitory computer-readable medium includes program code, that when executed by at least one processor of an electronic device, causes the electronic device to enable a diverse beamforming feature based on a diverse beamforming indication. The beamforming feature includes one or more beamIDs. The non-transitory computer-readable medium includes program code, that when executed by the at least one processor, also causes the electronic device to receive confirmation of the diverse beamforming feature being enabled from a DU. The non-transitory computer-readable medium includes program code, that when executed by the at least one processor, also causes the electronic device to configure a plurality of uplink U-plane ports such that each of the plurality of uplink U-plane ports having a different end point. The non-transitory computer-readable medium includes program code, that when executed by the at least one processor, also causes the electronic device to determine beamforming weights per uplink U-plane port. The non-transitory computer-readable medium includes program code, that when executed by the at least one processor, also causes the electronic device to apply the beamforming weights to the end point of the plurality of uplink U-plane ports to obtain a beamformed signal. The non-transitory computer-readable medium includes program code, that when executed by the at least one processor, also causes the electronic device to transmit the beamformed signal to the DU.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example base station according to embodiments of the present disclosure;

FIG. 3 illustrates an example UE according to embodiments of the present disclosure;

FIGS. 4A and 4B illustrate example wireless transmit and receive paths according to embodiments of the present disclosure;

FIG. 5 illustrates an example beamforming architecture according to embodiments of the present disclosure;

FIG. 6 illustrates an example open radio unit (O-RU) diverse beamforming configuration according to embodiments of the present disclosure;

FIG. 7 illustrates an example M-plane and C-plane signaling of a diverse beamforming configuration according to embodiments of the present disclosure;

FIG. 8 illustrates an example M-plane and C-plane signaling of a diverse beamforming configuration according to embodiments of the present disclosure;

FIG. 9 illustrates example group index and port index mapping according to embodiments of the present disclosure;

FIG. 10 illustrates an example M-plane and C-plane signaling of a diverse beamforming configuration according to embodiments of the present disclosure;

FIG. 11 illustrates an example M-plane and C-plane signaling of a diverse beamforming configuration according to embodiments of the present disclosure;

FIG. 12 illustrates an example M-plane and C-plane signaling of a diverse beamforming configuration according to embodiments of the present disclosure;

FIG. 13 illustrates an example M-plane and C-plane signaling of a diverse beamforming configuration according to embodiments of the present disclosure;

FIG. 14 illustrates an example M-plane and C-plane signaling of a diverse beamforming configuration according to embodiments of the present disclosure;

FIG. 15 illustrates an example M-plane and C-plane signaling of a diverse beamforming configuration according to embodiments of the present disclosure; and

FIG. 16 illustrates an example flow chart of a method for O-RAN fronthaul signaling for uplink beamforming according to embodiments of the present disclosure.

### DETAILED DESCRIPTION

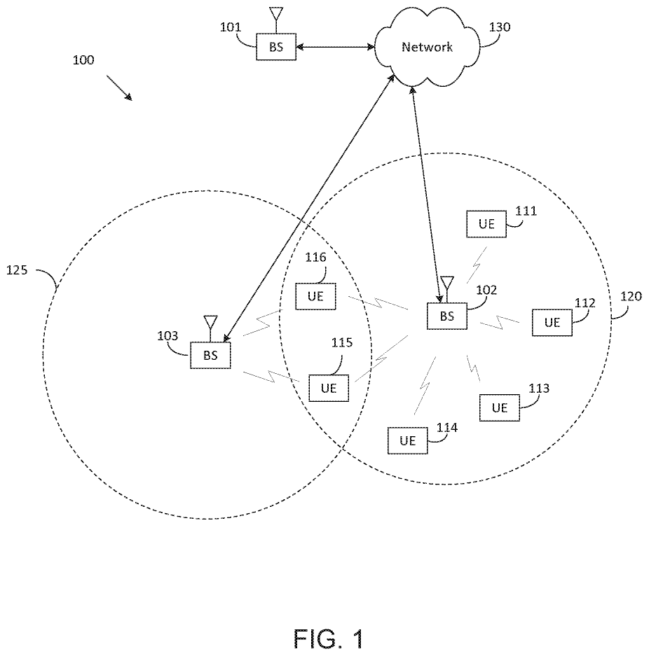

FIG. 1 through FIG. 16, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a base station (BS) 101, a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BSs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a 6G base station (aNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the base stations and variations in the radio environment associated with natural and manufactured obstructions.

As described in more detail below, one or more of the UEs 111-116 include circuitry, programing, or a combination thereof for transmitting on the uplink for O-RAN fronthaul signaling. In certain embodiments, one or more of the BSs 101-103 include circuitry, programing, or a combination thereof for O-RAN fronthaul signaling for uplink beamforming.

Although FIG. 1 illustrates one example of a wireless network, various changes may be made to FIG. 1. For example, the wireless network could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

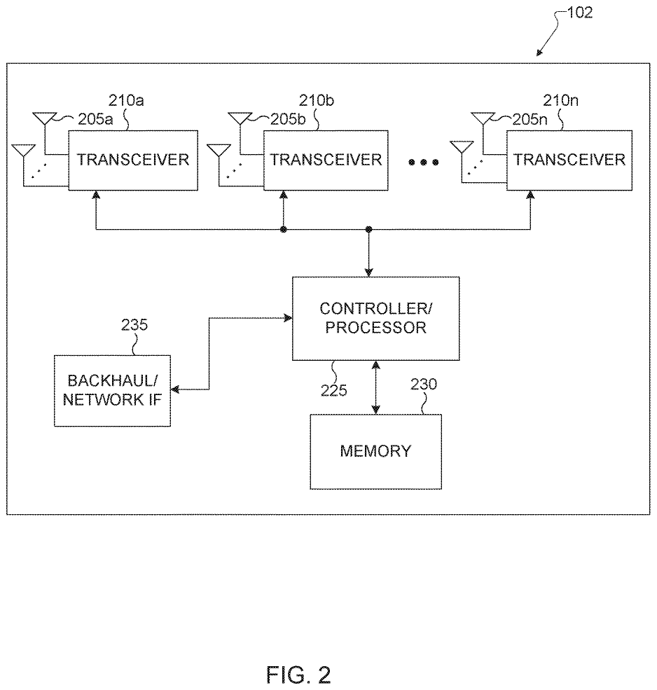

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of this disclosure to any particular implementation of a base station.

As shown in FIG. 2, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the BS 102 by the controller/processor 225.

The controller/processor 225 is also capable of executing programs and other processes resident in the memory 230, such as an OS. The controller/processor 225 can move data into or out of the memory 230 as required by an executing process. In various embodiments, controller/processor 225 includes circuitry, programing, or a combination thereof for O-RAN fronthaul signaling for uplink beamforming. For example, in various embodiments, the fronthaul signaling is performed over a wireless connection and antennas, such as antennas 205 and transceivers, such as transceivers 210 may be used to perform the wireless communications over the fronthaul.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a cellular communication system (such as one supporting 5G/NR, LTE, or LTE-A), the interface 235 could allow the BS 102 to communicate with other BSs over a wired or wireless backhaul connection. The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

In various embodiments, the O-RAN architecture includes a DU and an RU (or O-RAN DU (O-DU) and O-RAN RU (O-RU)). The DU is a logical node hosting higher layer functions based on a layer functional split and may be implemented in the BS 102. The RU is a logical node hosting a lower layer functions based on the functional split and may be implemented in the BS 102 such as network 130 in FIG. 1. The DU and RU may communicate over the a fronthaul interface in a control plane (C-plane) and a U-plane. In various embodiments, the RU and DU may be collocated within proximity of each other or may be distributed. Elements of the UL signal flows from the RU to the DU according to some embodiments of the O-RAN specification will be understood by those skilled in the art. For simplicity and clarity, the complete structure and operation of an O-RAN system is not depicted or described herein. Instead, only so much of an O-RAN system as is necessary for an understanding of the present disclosure is depicted and described.

Although FIG. 2 illustrates one example of BS 102, various changes may be made to FIG. 2. For example, the BS 102 could include any number of each component shown in FIG. 2. Also, various components in FIG. 2 could be combined, further subdivided, or omitted and additional components could be added according to particular needs.

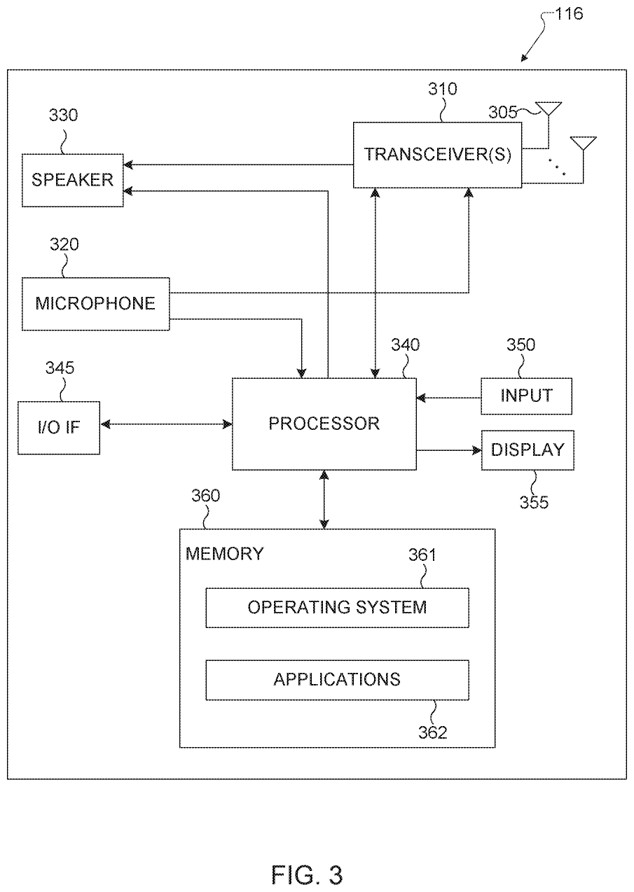

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a BS of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

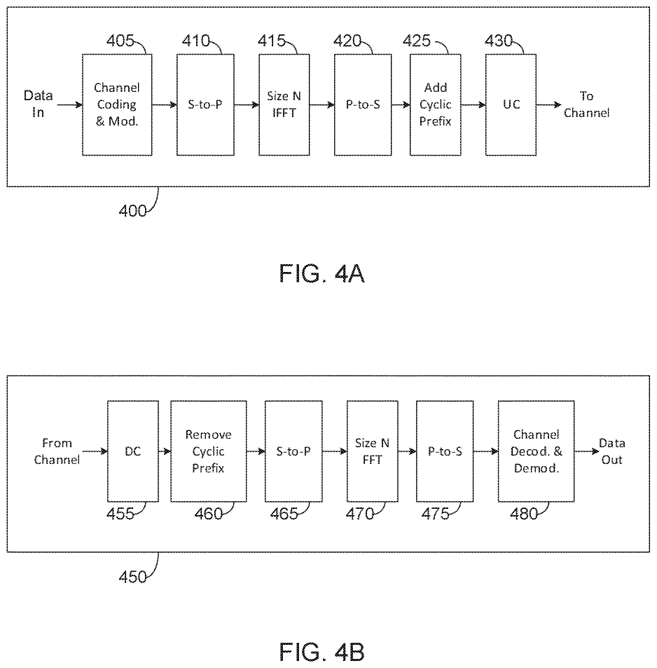

FIGS. 4A and 4B illustrate example wireless transmit and receive paths according to this disclosure. In the following description, a transmit path 400 may be described as being implemented in an RU (such as BS 102), while a receive path 450 may be described as being implemented in a DU (such as network 130). However, it will be understood that the receive path 450 can be implemented in an RU and that the transmit path 400 can be implemented in a DU. In some embodiments, the transmit path 400 is configured to support O-RAN fronthaul signaling for uplink beamforming as described in embodiments of the present disclosure.

The transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a serial-to-parallel (S-to-P) block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116. The down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time domain signals. The size N FFT block 470 performs an FFT algorithm to generate N parallel frequency-domain signals. The parallel-to-serial block 475 converts the parallel frequency-domain signals to a sequence of modulated data symbols. The channel decoding and demodulation block 480 demodulates and decodes the modulated symbols to recover the original input data stream.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Further, although described as using FFT and IFFT, other types of transforms, such as Discrete Fourier Transform (DFT) and Inverse Discrete Fourier Transform (IDFT) functions, can be used. It will be appreciated that the value of the variable N may be any integer number (such as 1, 4, 3, 4, or the like) for DFT and IDFT functions, while the value of the variable N may be any integer number that is a power of two (such as 1, 4, 4, 8, 16, or the like) for FFT and IFFT functions.

Although FIGS. 4A and 4B illustrate examples of wireless transmit and receive paths, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

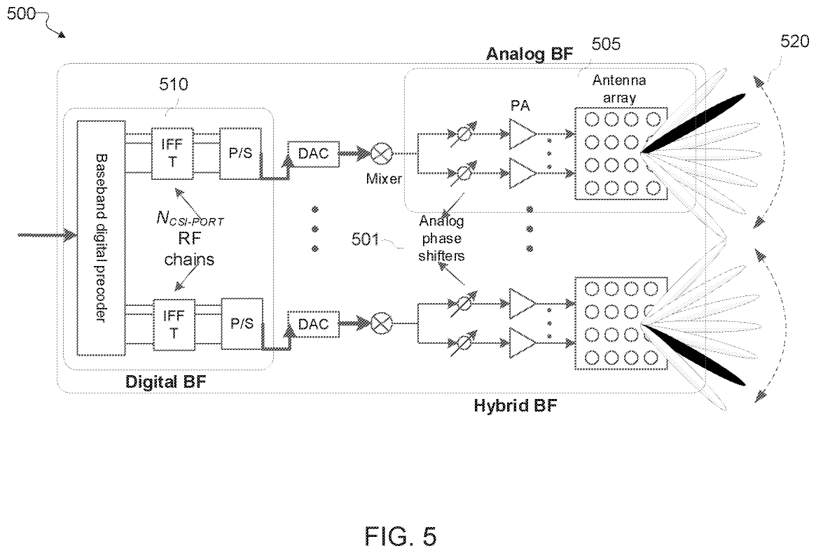

FIG. 5 illustrates an example of a transmitter structure 500 for beamforming according to embodiments of the present disclosure. In certain embodiments, one or more of RU or DU in the BS 102 or the network 130, respectively, includes the transmitter structure 500. For example, one or more of antennas 205 and its associated systems can be included in transmitter structure 500. This example is for illustration only and other embodiments can be used without departing from the scope of the present disclosure.

Rel.13 LTE supports up to 16 CSI-RS antenna ports which enable a gNB to be equipped with a large number of antenna elements (such as 64 or 128). In this case, a plurality of antenna elements is mapped onto one CSI-RS port. Furthermore, up to 32 CSI-RS ports will be supported in Rel.14 LTE. For next generation cellular systems such as 5G, it is expected that the maximum number of CSI-RS ports remain more or less the same.

For mm Wave bands, although the number of antenna elements can be larger for a given form factor, the number of CSI-RS ports-which can correspond to the number of digitally precoded ports-tends to be limited due to hardware constraints (such as the feasibility to install a large number of ADCs/DACs at mm Wave frequencies) as illustrated by beamforming architecture 500 in FIG. 5. In this case, one CSI-RS port is mapped onto a large number of antenna elements which can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or subframes or slots (wherein a subframe or a slot includes a collection of symbols and/or can include a transmission time interval). The number of sub-arrays (equal to the number of RF chains) is the same as the number of CSI-RS ports NCSI-PORT. A digital beamforming unit 510 performs a linear combination across NCSI-PORT analog beams to further increase precoding gain. While analog beams are wideband (hence not frequency-selective), digital precoding can be varied across frequency sub-bands or resource blocks.

In 5G New Radio (NR) or 6G networks, the Channel State Information Reference Signals (CSI-RS) are used to measure the channel quality and enable accurate channel estimation, beamforming, and link adaptation. However, the transmission of CSI-RS incurs significant overhead, which can lead to reduced spectral efficiency and increased latency.

In O-RAN, beamforming is used to direct radio signals more precisely toward a UE, improving signal quality and spectral efficiency. The beamforming process in O-RAN can be executed in different domains and configured using various methods. In the frequency domain, beamforming is performed digitally between the resource element (RE) mapping and the FFT/iFFT stages. This approach enables per-user beams within the same time slot, making the technique well suited for multi-user OFDM scenarios. In the time domain, beamforming is applied before the FFT/iFFT, either digitally or in the analog domain. Under this approach, all users share the same beam in a given time slot, which limits spatial selectivity. Hybrid beamforming combines time-domain and frequency-domain techniques, for example by applying time-domain beamforming for elevation and frequency-domain beamforming for azimuth, thereby balancing complexity and flexibility.

O-RAN supports five beamforming configuration approaches. The first is predefined-beam beamforming, which uses a beamId to indicate a predefined beam (whether time-domain, frequency-domain, or hybrid) configured in the O-RU. The O-DU must be aware of the beam type to apply the beam correctly, and the internal beam generation method in the O-RU is abstracted away. The second is weight-based dynamic beamforming, in which the O-DU computes beamforming weights in real time based on detailed O-RU antenna information, for example element count and spacing. Each beam corresponds to a beamId with an associated beamforming weights vector. The third is attribute-based dynamic beamforming, which is similar to the predefined-beam approach but links beamIds to a set of beam attributes, for example direction and width. The O-RU generates the beam accordingly, and the O-DU must know whether the beam is time-domain or frequency-domain based. The fourth is channel-information-based beamforming, in which the O-DU periodically sends channel information and per-slot scheduling details to the O-RU. The O-RU then calculates beam weights without using a beamId, relying instead on the ueId as the reference. The fifth is DMRS-based beamforming, which relies on Demodulation Reference Signals (DMRS) configuration. Under this approach, the O-RU estimates the channel and computes beamforming weights dynamically, without the use of a beamId.

For beamId-based methods, O-RAN allows the use of multiple beamId tables, which are configurable through the M-plane. A beamId may be associated with a beam (whether predefined, weighted, or attribute-based) either globally per O-RU or per beamId table. For channel-information-based beamforming and DMRS-based beamforming, a beamId is not used, and therefore beam table configuration does not apply.

In the legacy O-RAN fronthaul specifications, two problems arise. First, for beam-based uplink beamforming configuration, the combining beam to be used is determined by the O-DU ahead of the reception of the corresponding PUSCH. No mechanism exists in the legacy O-RAN fronthaul signaling that allows the O-RU to select or adjust the combining beam based on the received PUSCH. As a result, beam-based uplink beamforming can become outdated and suffer from channel aging. Second, when multiple uplink U-plane ports are configured by the O-DU, both the O-DU and the O-RU assume that the fronthaul ports are processed independently. However, this design prevents the O-RU from selecting more than one unique combining beam for use with different uplink U-plane ports, because selecting unique beams requires joint uplink U-plane port processing. Consequently, performance is limited in multi-path channel scenarios.

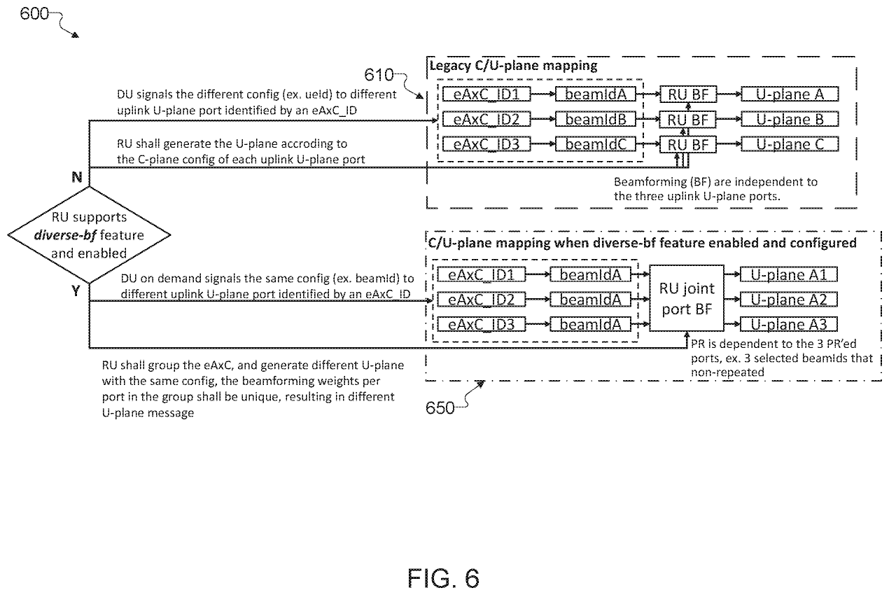

FIG. 6 illustrates an example O-RU diverse beamforming configuration 600 according to embodiments of the present disclosure. For ease of explanation, the O-RU diverse beamforming configuration 600 will be described as including one or more components of the wireless network 100 of FIG. 1, such as the BS 102; however, the O-RU diverse beamforming configuration 600 could be implemented using any other suitable device or system. The embodiment of the O-RU diverse beamforming configuration 600 shown in FIG. 6 is for illustration only. Other embodiments of the O-RU diverse beamforming configuration 600 could be used without departing from the scope of this disclosure.

A feature referred to as diverse-beamforming is disclosed for an O-RU. Under this feature, the O-RU declares support for diverse-beamforming to the O-DU through the M-plane, and the O-DU configures the O-RU to enable or disable diverse-beamforming through the M-plane.

As shown in FIG. 6, the O-RU diverse beamforming configuration 600 includes a legacy mapping portion 610 and a diverse beamforming portion 650. In C-plane uplink beamforming configurations, the behavior of the O-RU diverse beamforming configuration 600 depends on whether diverse-beamforming is active. When the diverse-beamforming feature is absent or disabled, the O-DU configures the uplink beamforming, and the O-RU applies the configuration in accordance with legacy O-RAN specifications, as shown in the legacy mapping portion 610.

When the diverse-beamforming feature is enabled, the O-DU configures one or more uplink U-plane ports with the same end-points and the same beam indicator in different uplink fronthaul ports. The O-RU groups the uplink U-plane ports sharing the same end-points and the same beam indicator and then jointly selects a unique combining beam per uplink U-plane port, so that different beamforming weights are applied to different uplink U-plane ports in the group, for example, based on received PUSCH I/Q samples, as shown in the diverse beamforming portion 650.

The C-plane indication of diverse-beamforming may be provided through a dedicated beamId, or through a dedicated ST and ST or SE. The O-DU may also configure the OFDM symbol on which the O-RU performs beamforming weight selection. Additionally, the O-DU may configure candidate beamId values or beamforming weights for the O-RU to use in performing beamforming weight selection.

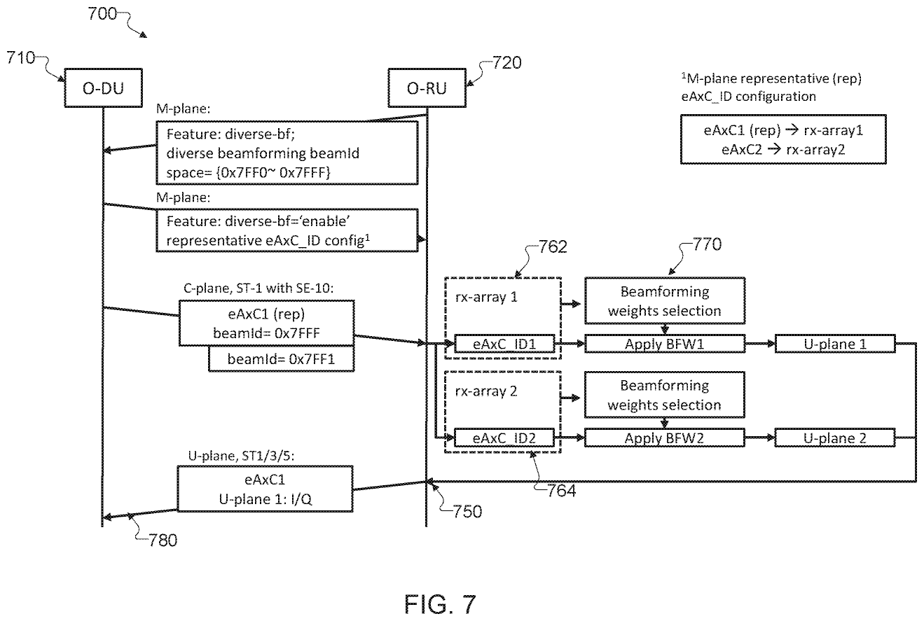

Although FIG. 6 illustrates one example of an O-RU diverse beamforming configuration, various changes may be made to FIG. 6. For example, various components of FIG. 6 could be combined, further subdivided, or omitted and additional components could be added according to particular needs. Additionally, the O-RU diverse beamforming configuration may include M-plane and C-plane signaling as shown in FIG. 7.

FIG. 7 illustrates an example M-plane and C-plane signaling 700 using dedicated beamId for one uplink U-plane port according to embodiments of the present disclosure. For ease of explanation, the signaling 700 will be described as including one or more components of the wireless network 100 of FIG. 1, such as the BS 102; however, the signaling 700 could be implemented using any other suitable device or system. The embodiment of the signaling 700 shown in FIG. 7 is for illustration only. Other embodiments of the signaling 700 could be used without departing from the scope of this disclosure.

As shown in FIG. 7, the M-plane and C-plane signaling 700 includes an O-DU 710 communicatively coupled to an O-RU 720 configured for M-plane signaling, C-plane signaling, and U-plane signaling.

The O-DU 710 uses a dedicated beam-Id for diverse-beamforming indication. Under this approach, the O-RU 720 reports one or multiple beam-Ids reserved for diverse-beamforming configuration, for example, referred to as diverse-beamforming beamIds. When the O-DU 710 configures an uplink U-plane port to the O-RU 720 through C-plane signaling ST-1 and/or SE1, SE11, or similar signaling, indicated with a diverse-beamforming beamId, the O-RU 720 is required to determine beamforming weights 770 and apply those beamforming weights 770 to the uplink U-plane port 750.

In one example, for each uplink U-plane port configured with a diverse-beamforming beamId, where the U-plane ports 750 are associated with different end-points or with the same end-point using different antenna masks, the O-RU 720 determines the beamforming weights 770 independently from other uplink U-plane ports 750. The diverse beamforming feature is reported from the O-RU 720 to the O-DU 710, together with a set of beamIds reserved for diverse beamforming. Once the O-DU 710 enables the diverse beamforming feature, the O-DU 710 configures two uplink U-plane ports 750 associated with two different end-points, for example, a first receiving array 762 and a second receiving array 764, with each port configured using one of the diverse beamforming beamIds. The O-RU 720 then determines beamforming weights 770 per uplink U-plane port, for example, by selecting one beam from an O-RU 720 beam book and applies those weights 770 to the corresponding end-point to obtain one port of beamformed signal 780. The O-RU 720 then transmits the beamformed signal 780 through U-plane to the O-DU 710.

When multiple uplink U-plane ports 750 with diverse-beamforming beamIds are configured, the O-DU 710 configures the uplink U-plane ports 750 to be associated with different end-points or the same end-points using different antenna masks. If the uplink U-plane ports 750 are associated with the same end-point and the same antenna mask, the O-RU 720 is expected to determine the same or different beamforming weights.

In legacy O-RAN configurations, beam-based uplink beamforming is configured by a beam identifier determined by the O-DU 710. The O-RU 720 uses a look-up table to obtain the beamforming weight mapped to the beam identifier.

Under the diverse beamforming approach, the O-RU 720 is the entity that determines the beamforming weights by performing beamforming weight selection. For example, the O-RU 720 attempts to apply N beamforming weights to the received signal and selects the one from N that yields the highest power. Additionally, unlike the legacy O-RAN approach, the beam identifier for diverse beamforming is not associated with any beamforming weights.

Although the O-DU 710 configures only one uplink port, the O-RU 720 performs beamforming weight selection based on the received signal due to the diverse beamforming configuration. Regarding diversity in beamforming, the O-DU 710 may continue to use a beamID of 0x7FFF in multiple C-plane messages. However, the actual beams the O-RU 720 applies may differ from one instance to the next, showing the “diverse” characteristic on a time scale.

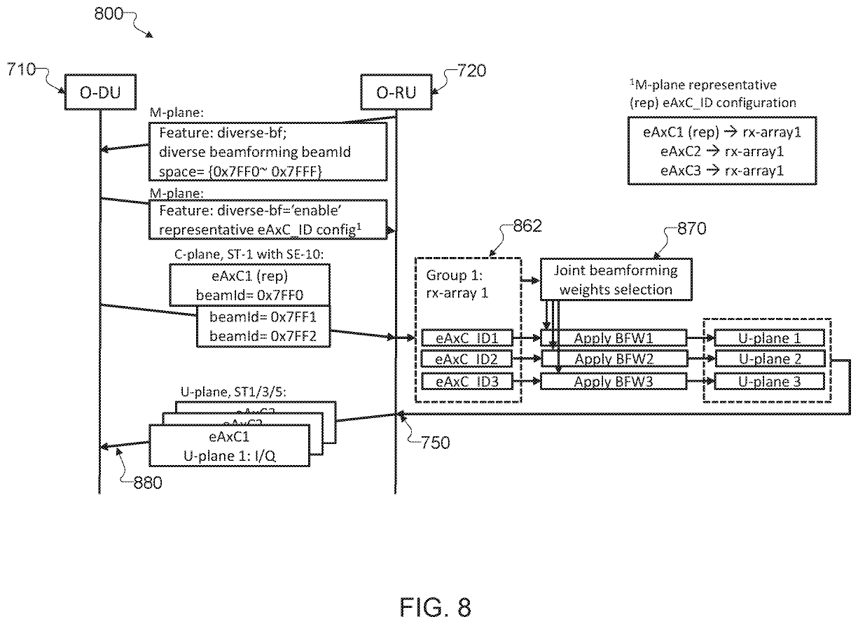

Although FIG. 7 illustrates one example of M-plane and C-plane signaling 700 using dedicated beamId for one uplink U-plane port, various changes may be made to FIG. 7. For example, various components of FIG. 7 could be combined, further subdivided, or omitted and additional components could be added according to particular needs. Additionally, the M-plane and C-plane signaling may include using dedicated beamIds for multiple uplink U-plane ports as shown in FIG. 8.

FIG. 8 illustrates an example M-plane and C-plane signaling 800 using dedicated beamIds for multiple uplink U-plane ports according to embodiments of the present disclosure. For ease of explanation, the signaling 800 will be described as including one or more components of the wireless network 100 of FIG. 1, such as the BS 102; however, the signaling 800 could be implemented using any other suitable device or system. The embodiment of the signaling 800 shown in FIG. 8 is for illustration only. Other embodiments of the signaling 800 could be used without departing from the scope of this disclosure.

As shown in FIG. 8, the O-RU 720 groups the uplink U-plane ports 750 that are configured with the same end-point and the same antenna mask, where each port is configured with one of the diverse-beamforming beamIds. The beamforming weights 870 of the grouped uplink U-plane ports 750 are jointly determined such that unique beamforming weights 870 are used for different uplink U-plane ports 750.

The diverse beamforming feature is reported from the O-RU 720 to the O-DU 710, together with a set of beamIds reserved for diverse beamforming. Once the O-DU 710 enables the diverse beamforming feature, the O-DU 710 configures multiple uplink U-plane ports 750, for example, three. The uplink U-plane ports 750 are configured with the same end-point, for example, where all the eAxC_IDs are associated with first receiving array 862, and the same antenna mask is configured, for example, where no explicit antenna mask configuration indicates that all antenna ports in first receiving array 762 are used. In addition, the uplink U-plane ports 750 are each configured with one of the diverse beamforming beamIds. The O-RU 720 then groups the uplink U-plane ports 750 as group 1. The O-RU 720 determines the beamforming weights 870 jointly among the uplink U-plane ports 750 within each group, for example, by selecting three different beams from an O-RU 720 beam book for the three uplink U-plane ports 750 and applies the beamforming weights 870 to the end-point to obtain three ports of beamformed signal 880. Finally, the O-RU 720 transmits the beamformed signals 880 through the U-plane to the O-DU 710.

With respect to M-plane signaling, the M-plane capability report is relevant. An example of a YANG-model for diverse-beamforming capability indication is shown below.

```
In o-ran-beamforming.yang:
feature DIVERSE-BEAMFORMING {
  description
    “This feature indicates that the O-RU supports an optional feature to
    determine a beamforming weights for an end-point”;
}
Container diverse-beamforming {
  Leaf diverse-bemforming-supported {
      If-feature DIVERSE-BEAMFORMING;
      Type boolean;
      Description
        “informs if dynamic beamforming is supported by the O-RU,
        If the value is true, and the dynamic beamforming is indicated in the
        C-plane message, the O-RU selects the beamforming weights and applies
        in the beamforming; if the values is false, the O-RU follow does not
        perform diverse beamforming.”;
  }
  Leaf max-number-of-end-point-groups {
      Type uint8;
      Description
        “Indicates the maximum number of end-point groups can be configured in
          the C-plane in the diverse beamforming.”;
  }
  Leaf max-number-of-end-points-per-group {
      Type uint8;
      Description
        “Indicates the maximum number of the end-points can be configured in
          each end-point group. The O-RU shall select different beamforming
          weights for the end-points in an end-point group.”
  }
}
```

The primary distinction between M-plane and C-plane signaling 700 and M-plane and C-plane signaling 800 is that, in M-plane and C-plane signaling 800, the O-DU 710 configures multiple ports to the O-RU 720 for the same receive array, whereas in M-plane and C-plane signaling 700, the O-DU 710 configures only a single port for the same receive array. Because of diverse beamforming, the O-RU 720 is required to perform beamforming weight selection.

Given that the O-DU 710 configures multiple ports, this selection should be a joint beamforming weight selection process. For example, the O-RU 720 may attempt to apply N beamforming weights 870 to the received signal and then identify three distinct weights 870 from among the N candidates that yield the highest power, where three corresponds to the number of ports 750. Accordingly, the O-RU 720 should jointly select the beamforming weights 870 rather than independently processing the uplink ports, as independent processing was assumed under the legacy O-RAN approach, which did not include a concept of selection. In M-plane and C-plane signaling 800, the diverse beamforming is reflected in in the time scale and in the port domain.

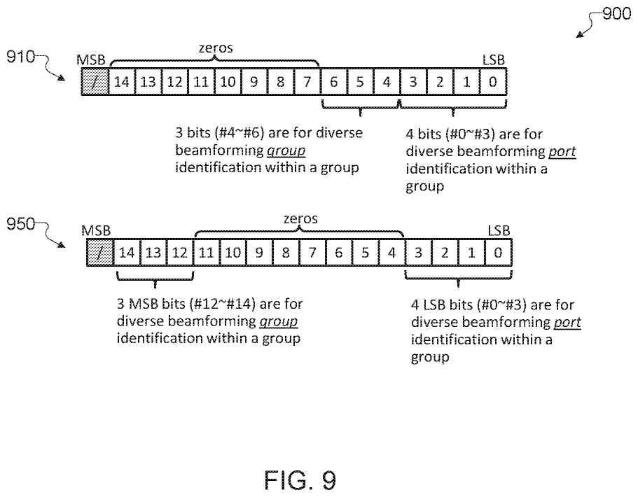

Although FIG. 8 illustrates one example of M-plane and C-plane signaling using dedicated beamIds for multiple uplink U-plane ports, various changes may be made to FIG. 8. For example, various components of FIG. 8 could be combined, further subdivided, or omitted and additional components could be added according to particular needs. Additionally, the M-plane and C-plane signaling may include group index and port index mapping as shown in FIG. 9.

FIG. 9 illustrates an example group index and port index mapping 900 within a beamId according to embodiments of the present disclosure. For ease of explanation, the mapping 900 will be described as including one or more components of the wireless network 100 of FIG. 1, such as the BS 102; however, the mapping 900 could be implemented using any other suitable device or system. The embodiment of the mapping 900 shown in FIG. 9 is for illustration only. Other embodiments of the mapping 900 could be used without departing from the scope of this disclosure.

As shown in FIG. 9, the group index and port index mapping 900 may implement the diverse beamforming beamId format. For example, the same diverse beamforming beamId is used, and the groups are implicitly partitioned based on the end-point, the antenna mask, and the presence of the diverse beamforming beamId. Additionally or alternatively, uplink U-plane ports 750 sharing the same diverse beamforming beamId are placed in the same group. Different diverse beamforming beamIds indicate different groups, thereby enabling the O-RU 720 to identify multiple groups in diverse beamforming.

Additionally or alternatively, different diverse beamforming beamIds are used for different groups and for different ports within the same group, thereby enabling the O-RU 720 to identify both the multiple groups and the ports within each group in diverse beamforming. The group index and the port index within a group are explicitly configured to the O-RU 720.

In a first index map 910, Np=4 bits starting from the LSB indicate the port index within a group, and the Ng=3 bits starting from the LSB plus Np bits are used for group index indication. The O-RU 720 to O-DU 710 M-plane configuration includes Np and Ng in the diverse beamforming beamId configuration. The remaining bits serve as a bit-mask for distinguishing the diverse beamforming beamId from other beamIds. Such a mask is indicated through the M-plane and can take the form of zero-padding, one-padding, or a dedicated bit-mask. An example of the YANG-model is shown below.

```
Container ul-predefined-beams {
  list diverse-bf-beam-id {
    key “beam-id”;
    leaf beam-id {
      type uint16;
      description “15-bit beamId, the MSB is reserved”;
    }
    leaf num-bits-port-index {
      type uint8;
      description “number of reserved bits start from LSB for port
indexing within the same group in diverse beamforming”;
    }
    leaf num-bits-group-index {
      type uint8;
      description “number of reserved bits start from LSB plus for the
number of bits for port indexing, these bits are for group indexing in
diverse beamforming”;
    }
    choice diverse-bf-beam-id-mask {
      case zero-padding {
        description “non-reserved bits in the beamId are zeros, meaning
the beamId is a diverse beamforming beamId”
      }
      case one-padding {
        description “non-reserved bits in the beamId are ones, meaning
the beamId is a diverse beamforming beamId”
      }
      case beam-id-mask {
        type uint16;
        description “when non-reserved bits in the beamId are the same
as the non-reserved bits in the beam-id-mask, meaning the beamId is a
diverse beamforming beamId”
      }
    }
  }
}
```

In the first index map 910, the O-DU 710 uses the same diverse-beamforming beam identifier for three uplink ports, and the O-RU 720 sends three different ports back to the O-DU 710 in the user plane. In legacy O-RAN operation, the O-RU 720 sends three ports with exactly the same in-phase and quadrature data, and the beamforming weights are already associated with the beam identifier.

In a second index map 950, Np=4 bits starting from the LSB indicate the port index within a group, and the Ng=3 bits starting from the MSB are used for group index indication. The O-RU 720 to O-DU 710 M-plane configuration includes two bit-masks in the diverse beamforming beamId configuration. One bit-mask, such as Mp=[000 0000 0000 1111], is used for port indexing, and the other bit-mask, such as Mg=[111 0000 0000 0000], is used for group indexing. The remaining bits serve as a bit-mask for distinguishing the diverse beamforming beamId from other beamIds. Such a mask is indicated through the M-plane and can take the form of zero-padding, one-padding, or a dedicated bit-mask. An example of the YANG-model is shown below.

```
Container ul-predefined-beams {
  list diverse-bf-beam-id {
    key “beam-id”;
    leaf beam-id {
      type uint16;
      description “15-bit beamId, the MSB is reserved”;
    }
    leaf port-index-mask {
      type uint16;
      description “a bit-mask, in which the bit locations of ones are
reserved bits in the beamId for port indexing within the same group in
diverse beamforming”;
    }
      leaf group-index-mask {
      type uint16;
      description “a bit-mask, in which the bit locations of ones are
reserved bits in the beamId for group indexing in diverse beamforming”;
    }
    choice diverse-bf-beam-id-mask {
      case zero-padding {
        description “non-reserved bits in the beamId are zeros, meaning
the beamId is a diverse beamforming beamId”
      }
      case one-padding {
        description “non-reserved bits in the beamId are ones, meaning
the beamId is a diverse beamforming beamId”
      }
      case beam-id-mask {
        type uint16;
        description “when non-reserved bits in the beamId are the same
as the non-reserved bits in the beam-id-mask, meaning the beamId is a
diverse beamforming beamId”
      }
    }
  }
}
```

In the second index map 950, the O-DU 710 uses a different diverse-beamforming beam identifier for each of the three uplink ports, and the O-RU 720 sends three different ports back to the O-DU 710 in the user plane. The different beam identifiers serve the convenience of the O-RU 720 rather than affecting the selection of beamforming weights. In legacy O-RAN operation, the O-RU 720 sends three ports with different in-phase and quadrature data. However, the beamforming weights are already associated with the beam identifier.

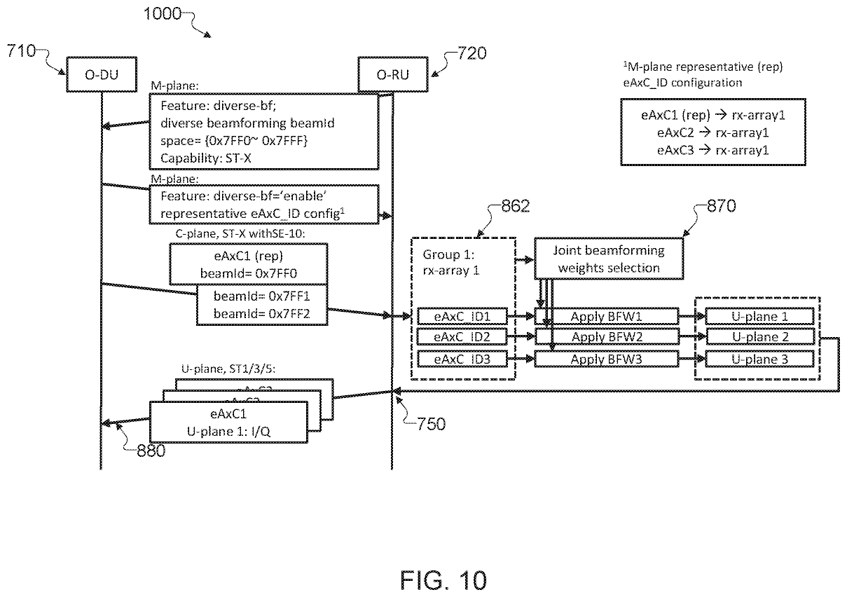

Although FIG. 9 illustrates one example of group index and port index mapping within the 15-bit beamId, various changes may be made to FIG. 9. For example, various components of FIG. 9 could be combined, further subdivided, or omitted and additional components could be added according to particular needs. Additionally, the M-plane and C-plane signaling may include using ST-X and dedicated beamIds for multiple uplink U-plane ports as shown in FIG. 10.

FIG. 10 illustrates an example M-plane and C-plane signaling 1000 of a diverse beamforming configuration using ST-X and dedicated beamIds for multiple uplink U-plane ports according to embodiments of the present disclosure. For ease of explanation, the signaling 1000 will be described as including one or more components of the wireless network 100 of FIG. 1, such as the BS 102; however, the signaling 1000 could be implemented using any other suitable device or system. The embodiment of the signaling 1000 shown in FIG. 10 is for illustration only. Other embodiments of the signaling 1000 could be used without departing from the scope of this disclosure.

As shown in FIG. 10, the O-DU 710 configures diverse-beamforming through a dedicated ST-X or SE-X. Based on the index of the ST or SE, the O-RU 720 is explicitly configured to perform diverse-beamforming.

Additionally or alternatively, when ST-X is configured, the O-RU 720 performs diverse-beamforming, and when ST-X is not configured, the O-RU 720 performs legacy beamforming. An example of ST-X is shown in TABLE 1, which has minimal differences from the existing ST-1 for pre-defined beam-based beamforming configuration. If the diverse-beamforming feature is supported and enabled, and the O-RU 720 receives an ST with a sectionType field equal to X, the O-RU 720 shall perform diverse-beamforming in the same manner as illustrated in FIG. 7.

In one example, the beamId field in ST-X is ignored. Alternatively, the beamId field in ST-X is a reserved beamId designated for diverse-beamforming. In this latter example, the only difference from the first embodiment is the use of ST-X instead of ST-1.

TABLE 1
Dedicate ST-X for Diverse-Beamforming Indication
with the Minimum Difference From ST-1
Section Type X: DL/UL control msgs

| | | | | | | | | |
|---|---|---|---|---|---|---|---|---|
| 0 | | | | | | | 7 | # of |
| (msb) | 1 | 2 | 3 | 4 | 5 | 6 | (lsb) | bytes |

| transport header | | | 8 | Octet |
|---|---|---|---|---|
| | | | | 1 |
| dataDirection | payloadVersion | filterIndex | 1 | Octet |

| | | | 9 |
|---|---|---|---|
| frameId | | 1 | Octet |
| | | | 10 |
| subframeId | slotId | 1 | Octet |

| | | | 11 |
|---|---|---|---|
| slotId | startSymbolId | 1 | Octet |

| | | | | | 12 |
|---|---|---|---|---|---|
| numberOfsections | | | | 1 | Octet |
| | | | | | 13 |
| sectionType = X | | | | 1 | Octet |
| | | | | | 14 |
| udCompHdr | | | | 1 | Octet |
| | | | | | 15 |
| reserved | | | | 1 | Octet |
| | | | | | 16 |
| sectionId | | | | 1 | Octet |
| | | | | | 17 |
| sectionId | rb | symInc | startPrbc | 1 | Octet |

| | | | 18 |
|---|---|---|---|
| startPrbc | | 1 | Octet |
| | | | 19 |
| numPrbc | | 1 | Octet |
| | | | 20 |
| reMask[11:4] | | 1 | Octet |
| | | | 21 |
| reMask[3:0] | numSymbol | 1 | Octet |

| | | | 22 |
|---|---|---|---|
| ef = 1 | beamId[14:8] | 1 | Octet |

| | | | | | 23 |
|---|---|---|---|---|---|
| beamId[7:0] | | | | 1 | Octet |
| | | | | | 24 |
| Section Extensions as indicated by “ef” | | | | var | Octet |
| | | | | | 25 |
| . . . | | | | | |
| sectionId | | | | 1 | Octet |
| | | | | | N |
| sectionId | rb | symInc | startPrbc | 1 | N + 1 |

| startPrbc | | 1 | N + 2 |
|---|---|---|---|
| numPrbc | | 1 | N + 3 |
| reMask[11:4] | | 1 | N + 4 |
| reMask[3:0] | numSymbol | 1 | N + 5 |

| | | | |
|---|---|---|---|
| ef = 0 | beamId[14:8] | 1 | N + 6 |

| | | |
|---|---|---|
| beamId[7:0] | 1 | N + 7 |
| Section Extensions as indicated by “ef” | var | N + 8 |

NOTE:
Shading: yellow is transport header, pink is radio application header, others are repeated sections

With respect to the configuration of one or multiple groups and one or multiple ports 750 within a group in diverse-beamforming, the SE-10 may be used as in FIG. 7 for multiple uplink U-plane port configurations. The beamIds in both ST-X and SE-10 are reserved beamIds designated for diverse-beamforming. The sectionType is X, indicating the use of diverse-beamforming at the O-RU 720, and the beamId assists the O-RU 720 in grouping the ports 750. Additionally, no beamId reservation is required for diverse-beamforming, allowing the beamId resources to be free for legacy O-RAN usage.

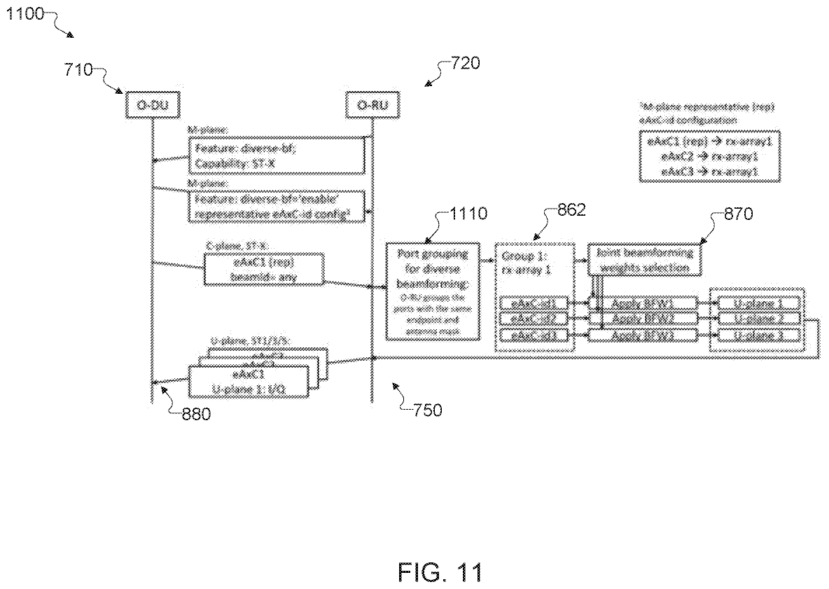

Although FIG. 10 illustrates example M-plane and C-plane signaling 1000 of a diverse beamforming configuration using ST-X and dedicated beamIds for multiple uplink U-plane ports, various changes may be made to FIG. 10. For example, various components of FIG. 10 could be combined, further subdivided, or omitted and additional components could be added according to particular needs. Additionally, the M-plane and C-plane signaling may include using ST-X for multiple uplink U-plane ports as shown in FIG. 11.

FIG. 11 illustrates an example M-plane and C-plane signaling 1100 of diverse beamforming configurations using ST-X for multiple uplink U-plane ports according to embodiments of the present disclosure. For ease of explanation, the M-plane and C-plane signaling 1100 will be described as including one or more components of the wireless network 100 of FIG. 1, such as the BS 102; however, the M-plane and C-plane signaling 1100 could be implemented using any other suitable device or system. The embodiment of the M-plane and C-plane signaling 1100 shown in FIG. 11 is for illustration only. Other embodiments of the M-plane and C-plane signaling 1100 could be used without departing from the scope of this disclosure.

As shown in FIG. 11, the M-plane and C-plane signaling 1100 includes no additional beamId beyond the one in ST-X is configured, meaning that SE-10 is not configured. For the M-plane and C-plane signaling 1100, SE refers to section extension, which is attached after section type, or ST. The X in ST-X and SE-X serves as an indicator for diverse-beamforming, allowing the O-DU 720 to use ST-1 combined with SE-X for diverse-beamforming indication.

Additionally, ST-X extends from SE-10, which includes numPortc to indicate the number of ports and beamGroupType for two modes, similar to diverseBFCfgType for diverse beamforming configuration type.

Unlike SE-10, diverseBFCfgType does not change beamforming weight selection. Regardless of whether diverseBFCfgType equals 00b or 01b, the U-plane should remain the same.

The diverseBFCfgType in SE-X provides for two alternatives regarding beamId usage in diverse-bf, similar to Alt1 and Alt2 on slide page 6. In the first alternative, all uplink ports are configured with diverse-bf and use the same beamId. Under this alternative, diverseBFCfgType equals 00b, and SE-X does not carry any beamId value. In the second alternative, although the uplink ports are configured with diverse-bf, different uplink ports are configured with different beamId values for RU convenience. Under this alternative, diverseBFCfgType equals 01b, and all beamId values are contained in SE-X.

If the eAxC_ID in ST-X is a representative eAxC_ID, ST-X configures multiple uplink U-plane ports 750 as though SE-10 were present. In this example, the groups and the ports within those groups are implicitly configured to the O-RU 720. The O-RU 720 groups the uplink U-plane ports 750 that share the same end-point and the same antenna mask, if configured.

Although only one beamId exists in the configuration, the O-RU 720 performs diverse-beamforming because the sectionType is X. Three uplink U-plane ports 750 are configured because the eAxC_ID in the ST-X header is configured through the M-plane as a represented eAxC_ID and is associated with two additional eAxC_IDs. The three uplink U-plane ports 750 belong to one group 1110 because the end-point associated with all three eAxC_IDs is the first receiving array 862. The O-RU 720 jointly determines beamforming weights 870 for the three ports 750.

Alternatively, when a legacy ST with SE-X is configured, or when ST-X with SE-X is configured, the O-RU 720 performs diverse-beamforming. Otherwise, the O-RU 720 performs legacy beamforming. When the SE-X is present, the O-RU 720 performs diverse-beamforming, and the beamId in the ST section does not indicate any predefined beam to use.

For example, the SE-X is shown in TABLE 2, where the extType equal to X indicates the use of diverse-beamforming. The field numPortc represents the number of uplink U-plane ports 750 configured, which is also equal to the number of eAxC_IDs associated with the representative eAxC_ID in the ST header. The beamId in the ST does not indicate which beamforming weight 870 to use.

TABLE 2
SE-X for diverse-beamforming configuration with diverseBfCfgType =
00b for beamId absent in the SE-X

| | | | | | | | | |
|---|---|---|---|---|---|---|---|---|
| 0 | | | | | | | 7 | # of |
| (msb) | 1 | 2 | 3 | 4 | 5 | 6 | (lsb) | bytes |

| | | | |
|---|---|---|---|
| ef | extType = 0x0X | 1 | Octet N |

| extLen = 0x01 (1 word) | | 1 | N + 1 |
|---|---|---|---|
| diverseBfCfgType = 00b | numPortc | 1 | N + 2 |

| | | |
|---|---|---|
| reserved | 1 | N + 3 |

In another example, the SE-X is shown in TABLE 3 as a special form noted by, for example, diverseBfCfgType=01b. The extType equal to X indicates the use of diverse-beamforming. The field numPortc represents the number of uplink U-plane ports 750 configured, which is also equal to the number of eAxC_IDs associated with the representative eAxC_ID in the ST header. In total, numPortc-1 of the beamId values are in the SE-X, similar to SE-10. The beamId in the ST and SE-X do not indicate which beamforming weight to use. If dedicated beamId values for diverse-beamforming are used, the O-RU 720 parses the port grouping information from those beamId values, if applicable.

TABLE 3
SE-X for diverse-beamforming configuration with diverseBfCfgType =
01b for beamId present in the SE-X

| | | | | | | | | # of |
|---|---|---|---|---|---|---|---|---|
| 0 (msb) | 1 | 2 | 3 | 4 | 5 | 6 | 7 (lsb) | bytes |

| | | | |
|---|---|---|---|
| ef | extType = 0x0X | 1 | Octet N |

| extLen | | 1 | N + 1 |
|---|---|---|---|
| diverseBfCfgType = 01b | numPortc | 1 | N + 2 |

| reserved | 2^{nd} port beamId[14:8] (or ueId[14:8]) | 1 | N + 3 |
|---|---|---|---|
| 2^{nd} port beamId[7:0] (or ueId[7:0]) | | 1 | N + 4 |
| reserved | 3^{rd} port beamId[14:8] (or ueId[14:8]) | 1 | N + 5 |
| 3^{rd} port beamId[7:0] (or ueId[7:0]) | | 1 | N + 6 |
| reserved | . . . | 1 | var |
| . . . | | 1 | var |
| reserved | (numPortc + 1)^{th} port beamId[14:8] (or ueId[14:8]) | 1 | var |

| | | |
|---|---|---|
| (numPortc + 1)^{th} port beamId[7:0] (or ueId[7:0]) | 1 | var |
| filler to ensure 4-byte boundary | var | var |

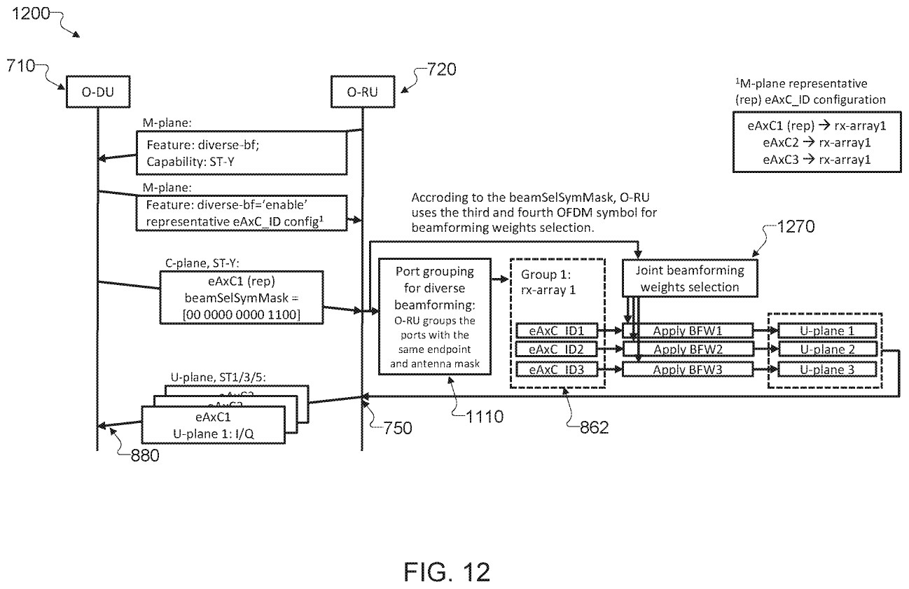

Although FIG. 11 illustrates one example of an M-plane and C-plane signaling using ST-X for multiple uplink U-plane port, various changes may be made to FIG. 11. For example, various components of FIG. 11 could be combined, further subdivided, or omitted and additional components could be added according to particular needs. Additionally, the M-plane and C-plane signaling may include using ST-Y for multiple uplink U-plane ports as shown in FIG. 12.

FIG. 12 illustrates example M-plane and C-plane signaling 1200 using ST-Y for multiple uplink U-plane port according to embodiments of the present disclosure. For ease of explanation, the signaling 1200 will be described as including one or more components of the wireless network 100 of FIG. 1, such as the BS 102; however, the signaling 1200 could be implemented using any other suitable device or system. The embodiment of the signaling 1200 shown in FIG. 12 is for illustration only. Other embodiments of the signaling 1200 could be used without departing from the scope of this disclosure.

As shown in FIG. 12, the O-DU 710 configures an OFDM symbol index for the O-RU 720 to perform beamforming weight selection in diverse beamforming. Specifically, the O-DU 710 configures diverse beamforming through ST-Y with an OFDM symbol indication specifying one or multiple received OFDM symbols on which the beamforming weights 1270 are determined. Through this configuration, the O-DU 710 is able to indicate a data symbol or a DMRS symbol for diverse-beamforming weight selection by the O-RU 720.

In one example, ST-Y is shown in TABLE 4. The O-RU 720 shall perform diverse beamforming when the sectionType is equal to Y. ST-Y includes a 14-bit OFDM symbol mask, for example beamSelSymMask, corresponding to the 14 OFDM symbols in a slot. A value of 0 indicates that the corresponding OFDM symbol is not designated for diverse-beamforming weight selection, while a value of 1 indicates that the corresponding OFDM symbol is to be used for diverse-beamforming weight selection.

TABLE 4
Dedicate ST-Y for diverse-beamforming indication with
an OFDM symbol mask for O-RU beamforming weights selection
Section Type Y: DL/UL control msgs

| | | | | | | | | # of |
|---|---|---|---|---|---|---|---|---|
| 0 (msb) | 1 | 2 | 3 | 4 | 5 | 6 | 7 (lsb) | bytes |

| transport header | | | 8 | Octet |
|---|---|---|---|---|
| | | | | 1 |
| dataDirection | payloadVersion | filterIndex | 1 | Octet |

| | | | 9 |
|---|---|---|---|
| frameId | | 1 | Octet |
| | | | 10 |
| subframeId | slotId | 1 | Octet |

| | | | 11 |
|---|---|---|---|
| slotId | startSymbolId | 1 | Octet |

| | | | | | 12 |
|---|---|---|---|---|---|
| numberOfsections | | | | 1 | Octet |
| | | | | | 13 |
| sectionType = Y | | | | 1 | Octet |
| | | | | | 14 |
| udCompHdr | | | | 1 | Octet |
| | | | | | 15 |
| reserved | | | | 1 | Octet |
| | | | | | 16 |
| sectionId | | | | 1 | Octet |
| | | | | | 17 |
| sectionId | rb | symInc | startPrbc | 1 | Octet |

| | | | 18 |
|---|---|---|---|
| startPrbc | | 1 | Octet |
| | | | 19 |
| numPrbc | | 1 | Octet |
| | | | 20 |
| reMask[11:4] | | 1 | Octet |
| | | | 21 |
| reMask[3:0] | numSymbol | 1 | Octet |

| | | | | 22 |
|---|---|---|---|---|
| ef = 1 | reserved | beamSelSymMask [13:8] | 1 | Octet |

| | | | | | 23 |
|---|---|---|---|---|---|
| beamSelSymMask [7:0] | | | | 1 | Octet |
| | | | | | 24 |
| Section Extensions as indicated by “ef” | | | | var | Octet |
| | | | | | 25 |
| . . . | | | | | |
| sectionId | | | | 1 | Octet |
| | | | | | N |
| sectionId | rb | symInc | startPrbc | 1 | N + 1 |

| startPrbc | | 1 | N + 2 |
|---|---|---|---|
| numPrbc | | 1 | N + 3 |
| reMask[11:4] | | 1 | N + 4 |
| reMask[3:0] | numSymbol | 1 | N + 5 |

| | | | | |
|---|---|---|---|---|
| ef = 0 | reserved | beamSelSymMask [14:8] | 1 | N + 6 |

| | | |
|---|---|---|
| beamSelSymMask [7:0] | 1 | N + 7 |
| Section Extensions as indicated by “ef” | var | N + 8 |

NOTE:
Shading: yellow is transport header, pink is radio application header, others are repeated sections

As shown in FIG. 12, although only one beamId exists in the configuration, the O-RU 720 performs diverse beamforming because the section Type is Y. Three uplink U-plane ports 750 are configured because the eAxC_ID in the ST-Y header is configured through the M-plane as a represented eAxC_ID and is associated with two additional eAxC_IDs. The three uplink U-plane ports 750 belong to one group 1110 because the endpoint associated with each of the three eAxC_IDs is the first receiving array 762. The O-RU 720 jointly determines the beamforming weights 1270 for the three ports 750. In ST-Y, the beamSelSymMask is configured as [00 0000 0000 1100], indicating that the third and fourth OFDM symbols are used for diverse-beamforming weight selection.

The O-RU 720 parses the port grouping by checking whether the endpoints and the antenna masks are the same for the port represented by the eAxC_ID in the header of ST-Y. An OFDM symbol mask is configured in ST-Y, and the O-RU 720 is expected to select beamforming weights based on the indicated OFDM symbols.

In M-plane and C-plane signaling 1200, the use of ST-Y presents two principal differences relative to the legacy O-RAN operation (ST-1). First, the section type index is designated as “Y,” which indicates the use of diverse-beamforming. Second, ST-Y includes a beam selection symbol mask known as “beamSelSymMask.” This mask indicates to the O-RU 720 which OFDM symbol should be used for beamforming weight selection.

The O-DU 710 configures the O-RU 720 to perform selection based on the DMRS symbol. However, the O-RU 720 does not possess information of which symbol in the slots corresponds to the DMRS. The O-DU 710 therefore provides a mask in ST-Y to support this process.

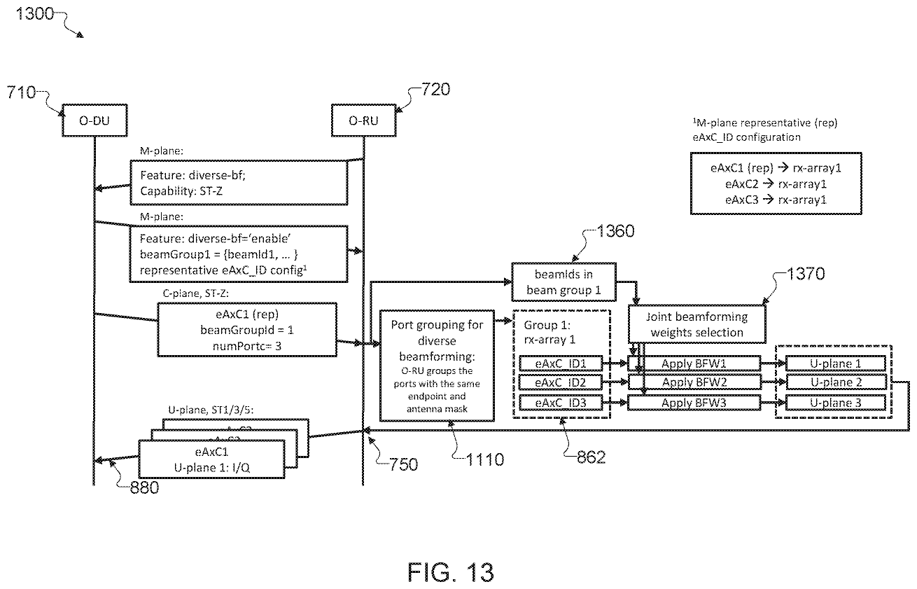

Although FIG. 12 illustrates one example of M-plane and C-plane signaling of diverse beamforming configuration using ST-Y for multiple uplink U-plane ports, various changes may be made to FIG. 12. For example, various components of FIG. 12 could be combined, further subdivided, or omitted and additional components could be added according to particular needs. Additionally, the M-plane and C-plane signaling may include using ST-Z for multiple uplink U-plane ports as shown in FIG. 13.

FIG. 13 illustrates example M-plane and C-plane signaling 1300 using ST-Z for multiple uplink U-plane ports according to embodiments of the present disclosure. For ease of explanation, the signaling 1300 will be described as including one or more components of the wireless network 100 of FIG. 1, such as the BS 102; however, the signaling 1300 could be implemented using any other suitable device or system. The embodiment of the signaling 1300 shown in FIG. 13 is for illustration only. Other embodiments of the signaling 1300 could be used without departing from the scope of this disclosure.

As shown in FIG. 13, the O-DU 710 configures the O-RU 720 with a set of candidate beamforming weights 1370 for use in diverse beamforming. Specifically, the O-DU 710 configures one or multiple sets of candidate beam identifiers 1360 or beamforming weights 1370 for diverse beamforming at the O-RU 720. The O-RU 720 then selects a unique entry from the candidate beam identifiers 1360 or beamforming weights 1370 for each uplink U-plane port within a group 1110, where the uplink U-plane ports 750 are configured with the same endpoints and the same antenna masks.

M-plane and C-plane signaling of the diverse beamforming configuration uses ST-Z for multiple uplink U-plane ports 750. For each group of uplink U-plane ports 750, a beam group identifier 1360 indicates a set of beam identifiers from which the O-RU 720 selects, and the number of uplink U-plane ports 750 is explicitly configured.

The capability of candidate selection in diverse beamforming is reported from the O-RU 720 to the O-DU 710 through the M-plane. In one alternative, the candidate selection capability is implicitly indicated through the capability of ST-Z or SE-Z, which are C-plane messages designated for diverse beamforming with candidate selection. In another alternative, the candidate selection capability is implicitly indicated through the parameters of diverse beamforming that are dedicated to candidate selection, and those parameters are reported from the O-RU 720 to the O-DU 710 through the M-plane. Alternatively, the candidate selection capability is explicitly indicated through the M-plane.

In the M-plane, the O-RU 720 reports to the O-DU 710 the feature capability of diverse beamforming, along with support for ST-Z or SE-Z, which are dedicated to diverse beamforming and candidate beam group configurations. The O-DU 710 enables the diverse beamforming feature of the O-RU 720 and configures one or multiple beam groups. Each beam group is mapped to one or multiple beam identifiers 1360. The beam identifiers 1360 are reported by the O-RU 720 or are associated with a set of beamforming weights 1370 configured at the O-RU 720. In the C-plane, the O-DU 710 configures one or multiple uplink U-plane ports 750 with ST-Z or SE-Z, indicating the use of diverse beamforming with candidate beam identifier configurations.

The use of ST-Y differs from legacy O-RAN operation by using the section type index “Z” to indicate the use of diverse-beamforming and including a “beamGroupId” to indicate a beam searching space. The inclusion of “beamGroupId” reduces O-RU 720 beam search complexity, as the O-DU 710 selects “beamGroupId” based on, for example, historical channel information such as PMI, SRS, and DMRS. Additionally, ST-Z includes “numPortc,” which indicates the number of ports in the uplink.

Under the legacy configuration, an ST without SE-10 is intended for single-port use, and SE-10 includes “numPortc” to indicate the total number of ports. With “numPortc” included directly in ST-Z, there is no need for SE-10 or SE-X. These parameters enable searching space indication, which reduces O-RU 720 searching complexity, and they allow ST-Z to support multi-port configuration without requiring SE-10 or SE-X.

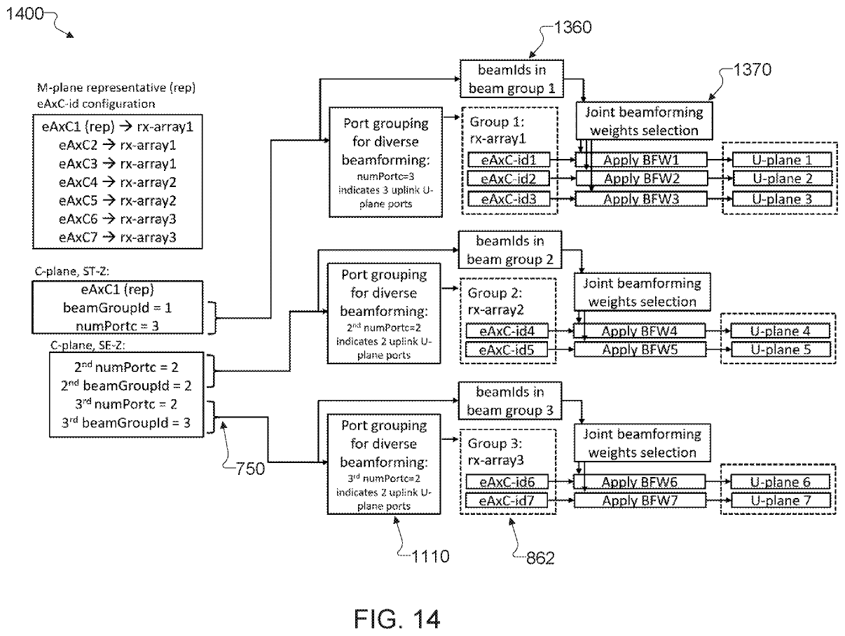

Although FIG. 13 illustrates one example of M-plane and C-plane signaling using ST-Z for multiple uplink U-plane ports, various changes may be made to FIG. 13. For example, various components of FIG. 13 could be combined, further subdivided, or omitted and additional components could be added according to particular needs. Additionally, the M-plane and C-plane signaling may include using ST-Z and SE-Z for multiple uplink U-plane ports as shown in FIG. 14.

FIG. 14 illustrates example M-plane and C-plane signaling 1400 using ST-Z and SE-Z for multiple uplink U-plane ports according to embodiments of the present disclosure. For ease of explanation, the signaling 1400 will be described as including one or more components of the wireless network 100 of FIG. 1, such as the BS 102; however, the signaling 1400 could be implemented using any other suitable device or system. The embodiment of the signaling 1400 shown in FIG. 14 is for illustration only. Other embodiments of the signaling 1400 could be used without departing from the scope of this disclosure.

As shown in FIG. 14, ST-Z and SE-Z are used for diverse-beamforming with candidate beamId configuration. The M-plane and C-plane signaling 1400 serves as an extension of M-plane and C-plane signaling 1300, where SE-Z supports uplink port grouping along with per-group beam searching domain configuration. In other words, the configuration shown in the M-plane and C-plane signaling 1400 supports multiple groups, thereby enabling more flexible and granular beam searching configurations across distinct sets of uplink ports.

For example, through ST-Z, the O-DU 710 configures the first group such that uplink ports 1, 2, and 3 are assigned to a first UE, with the system searching for three beams from beamGroupId=1, which maps to 32 beams. Through SE-Z, the O-DU 710 configures the second group such that uplink ports 4 and 5 are assigned to a second UE, with the system searching for two beams from beamGroupId=2, which maps to 16 beams. The O-DU 710 also configures the third group through SE-Z such that uplink ports 6 and 7 are assigned to a third UE, with the system searching for two beams from beamGroupId=3, which maps to another 16 beams.

An example of ST-Z is shown in TABLE 5, which includes several fields. The numPortc field indicates the number of uplink U-plane ports 750 in the first group of uplink U-plane ports 750 that share the same end-point and antenna mask configuration. The beamGroupId field is associated with a group of beamIds that are configured as candidate beamIds to be used for diverse-beamforming of the first numPortc uplink U-plane ports 750.

TABLE 5
Dedicate ST-Z for diverse-beamforming indication
with candidate beam group indications
Section Type Y: DL/UL control msgs

| | | | | | | | | |
|---|---|---|---|---|---|---|---|---|
| 0 | | | | | | | 7 | # of |
| (msb) | 1 | 2 | 3 | 4 | 5 | 6 | (lsb) | bytes |

| transport header | | | 8 | Octet |
|---|---|---|---|---|
| | | | | 1 |
| dataDirection | payloadVersion | filterIndex | 1 | Octet |

| | | | 9 |
|---|---|---|---|
| frameId | | 1 | Octet |
| | | | 10 |
| subframeId | slotId | 1 | Octet |

| | | | 11 |
|---|---|---|---|
| slotId | startSymbolId | 1 | Octet |

| | | | | | 12 |
|---|---|---|---|---|---|
| numberOfsections | | | | 1 | Octet |
| | | | | | 13 |
| sectionType = Z | | | | 1 | Octet |
| | | | | | 14 |
| udCompHdr | | | | 1 | Octet |
| | | | | | 15 |
| reserved | | | | 1 | Octet |
| | | | | | 16 |
| sectionId | | | | 1 | Octet |
| | | | | | 17 |
| sectionId | rb | symInc | startPrbc | 1 | Octet |

| | | | 18 |
|---|---|---|---|
| startPrbc | | 1 | Octet |
| | | | 19 |
| numPrbc | | 1 | Octet |
| | | | 20 |
| reMask[11:4] | | 1 | Octet |
| | | | 21 |
| reMask[3:0] | numSymbol | 1 | Octet |

| | | | | 22 |
|---|---|---|---|---|
| ef = 1 | reserved | numPortc | 1 | Octet |

| | | | | | 23 |
|---|---|---|---|---|---|
| beamGroupId | | | | 1 | Octet |
| | | | | | 24 |
| Section Extensions as indicated by “ef” | | | | var | Octet |
| | | | | | 25 |
| . . . | | | | | |
| sectionId | | | | 1 | Octet |
| | | | | | N |
| sectionId | rb | symInc | startPrbc | 1 | N + 1 |

| startPrbc | | 1 | N + 2 |
|---|---|---|---|
| numPrbc | | 1 | N + 3 |
| reMask[11:4] | | 1 | N + 4 |
| reMask[3:0] | numSymbol | 1 | N + 5 |

| | | | | |
|---|---|---|---|---|
| ef = 0 | reserved | numPortc | 1 | N + 6 |

| | | |
|---|---|---|
| beamGroupId | 1 | N + 7 |
| Section Extensions as indicated by “ef” | var | N + 8 |

NOTE:
Shading: yellow is transport header, pink is radio application header, others are repeated sections

When configured with multiple groups of uplink U-plane ports 750, SE-Z is attached to the ST-Z sections for configuring from the second to the last groups of uplink U-plane ports 750. An example of SE-Z is shown in TABLE 6, which also includes several fields. The K-th numPortc field indicates the number of uplink U-plane ports 750 in the K-th group of uplink U-plane ports 750 that share the same end-point and antenna mask configuration. The K-th beamGroupId field is associated with a group of beam identifiers 1360 that are configured as candidate beam identifiers 1360 to be used for diverse-beamforming of the K-th numPortc uplink U-plane ports 750.

TABLE 6
SE-Z for Diverse-Beamforming Candidate
Beam Identifiers Configuration

| | | | | | | | | # of |
|---|---|---|---|---|---|---|---|---|
| 0 (msb) | 1 | 2 | 3 | 4 | 5 | 6 | 7 (lsb) | bytes |

| | | | |
|---|---|---|---|
| ef | extType = 0x0Z | 1 | Octet N |

| extLen | | 1 | N + 1 |
|---|---|---|---|
| reserved | 2^{nd} numPortc | 1 | N + 2 |

| | | |
|---|---|---|
| 2^{nd} beamGroupId | 1 | N + 3 |

| . . . | | 1 | var |
|---|---|---|---|
| reserved | numPortc | 1 | var |

| | | |
|---|---|---|
| last beamGroupId | 1 | var |
| filler to ensure 4-byte boundary | var | var |

FIG. 14 shows an example of using ST-Z and SE-Z to configure three groups of uplink U-plane ports 750. According to ST-Z, the first group of uplink U-plane ports 750 has three ports whose eAxC_IDs are associated with an end-point identified as first receiving array 762. The beamGroup1 is used for diverse-beamforming, such that the O-RU 720 selects three identical beam identifiers 1360 for the three uplink U-plane ports 750 from the beam identifiers 1360 associated with beamGroup1. The configurations for the second and third groups of uplink U-plane ports 750 are included in SE-Z.

M-plane and C-plane signaling of diverse beamforming configuration using ST-Z and SE-Z supports multiple uplink U-plane ports 750. For each group of uplink U-plane ports 750, a beam group ID indicates a set of beam identifiers 1360 for the O-RU 720 to select, and the number of uplink U-plane ports 750 is explicitly configured.

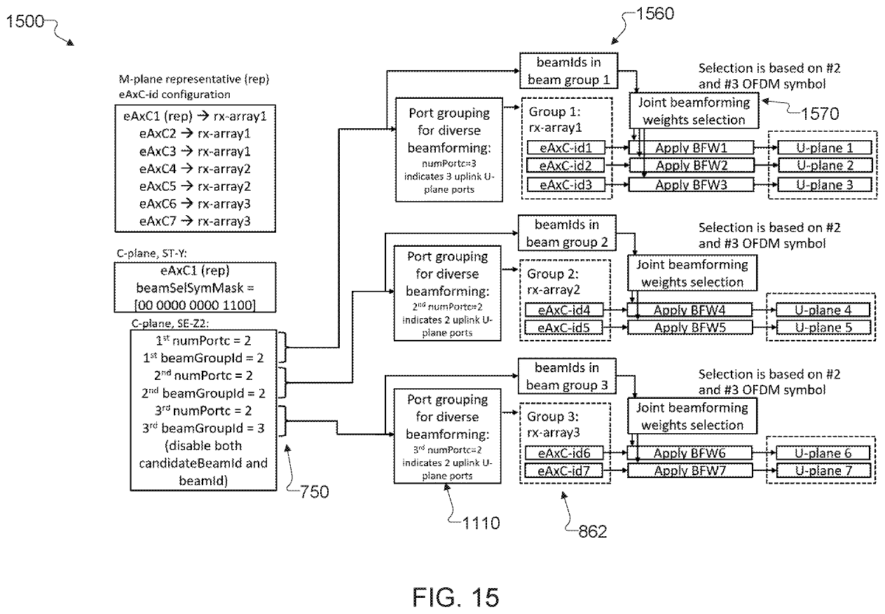

Although FIG. 14 illustrates one example of M-plane and C-plane signaling using ST-Z and SE-Z for multiple uplink U-plane ports, various changes may be made to FIG. 14. For example, various components of FIG. 14 could be combined, further subdivided, or omitted and additional components could be added according to particular needs. Additionally, the M-plane and C-plane signaling may include using ST-Y and SE-Z2 for multiple uplink U-plane ports as shown in FIG. 15.

FIG. 15 illustrates an example M-plane and C-plane signaling 1500 using ST-Y and SE-Z2 for multiple uplink U-plane ports according to embodiments of the present disclosure. For ease of explanation, the signaling 1500 will be described as including one or more components of the wireless network 100 of FIG. 1, such as the BS 102; however, the signaling 1500 could be implemented using any other suitable device or system. The embodiment of the signaling 1500 shown in FIG. 15 is for illustration only. Other embodiments of the signaling 1500 could be used without departing from the scope of this disclosure.

As shown in FIG. 15, ST-Y is used for diverse-beamforming indication with an OFDM symbol mask for O-RU 720 to perform beam identifier 1560 selection. A new section element, SE-Z2, is used for candidate beam identifier 1560 configuration for each group of uplink U-plane ports 750. An example of SE-Z2 is shown in TABLE 7, which includes the configuration for each group of uplink U-plane ports 750.

TABLE 7
SE-Z2 for Diverse-Beamforming Candidate Beamid Configuration

| | | | | | | | | # of |
|---|---|---|---|---|---|---|---|---|
| 0 (msb) | 1 | 2 | 3 | 4 | 5 | 6 | 7 (lsb) | bytes |

| ef | extType = 0xZ2 | | 1 | Octet N |
|---|---|---|---|---|
| extLen | | | 1 | N + 1 |
| disableCandidate | disable BeamId | 1^{st} numPortc = M₁ | 1 | N + 2 |
| reserved | 1^{st} beamGroupId [14:8] | | 1 | N + 3 |
| 1^{st} beamGroupId [7:0] | | | 1 | N + 4 |
| 1^{st} numCandidateBeamId = P₁ (if not disableCandidate) | | | 1 | var |
| 1^{st} candidateBeamId1 [15:0] (if not disableCandidate) | | | 2 | var |
| . . . | | | | |
| 1^{st} candidateBeamId P₁ [15:0] (if not disableCandidate) | | | 2 | var |
| 1^{st} beamId1 [14:0] (if not disableBeamId) | | | 2 | var |
| 1^{st} beamId M₁ [14:0] (if not disableBeamId) | | | 2 | var |
| . . . | | | | |
| disableCandidate | disable BeamId | K-th last numPortc = M_{K} | | |

| | |
|---|---|
| reserved | K-th beamGroupId [14:8] |

| | | |
|---|---|---|
| K-th beam GroupId [7:0] | | |
| K-th numCandidateBeamId = Pₗₐₛₜ (last group, if not disableCandidate) | 1 | var |
| K-th candidateBeamId1 [15:0] (last group, if not disableCandidate) | 2 | var |
| . . . | | |
| K-th candidateBeamId P_{K} [15:0] (if not disableCandidate) | 2 | var |
| K-th beamId1 [14:0] (if not disableBeamId) | 2 | var |
| . . . | | |
| K-th beamId M_{K} [14:0] (if not disableBeamId) | 2 | var |
| filler to ensure 4-byte boundary | var | var |

The M-plane and C-plane signaling 1500 extends the M-plane and C-plane signaling 1200 by enabling SE-Z to support uplink port grouping and per-group beam searching domain configuration to supports multiple groups.

For example, through ST-Y, the O-DU 710 configures which OFDM symbol to use for beamforming weight selection. Through SE-Z2, the O-DU 710 configures the three groups as follows. In the first group, uplink ports 1, 2, and 3 are assigned to a first UE, and the system searches for three beams from beamGroupId=1, which maps to 32 beams. In the second group, uplink ports 4 and 5 are assigned to a second UE, and the system searches for two beams from beamGroupId=2, which maps to 16 beams. In the third group, uplink ports 6 and 7 are assigned to a third UE, and the system searches for two beams from beamGroupId-3, which maps to another 16 beams.

The disableCandidate field indicates whether the list of candidate beam identifier 1560 values for a given group of uplink U-plane ports 750 exists in SE-X. A value of 0 means the list of candidate beam identifier 1560 values exists, and a value of 1 means the list of candidate beam identifier 1560 values is absent. The disableBeam identifier 1560 field indicates whether the list of per-port beam identifier 1560 values for a given group of uplink U-plane ports 750 exists in SE-X. A value of 0 means the list of beam identifier 1560 values exists, and a value of 1 means the list of beam identifier 1560 values is absent. The K-th numPortc field indicates the number of uplink U-plane ports 750 in the K-th group of uplink U-plane ports 750 that share the same end-point and antenna mask configuration. The K-th beamGroupId field is associated with a group of beam identifier 1560 values that are configured as candidate beam identifier 1560 values to be used for diverse-beamforming of the K-th numPortc uplink U-plane ports 750. The K-th numCandidateBeamId field indicates the number of candidate beam identifier 1560 values corresponding to the K-th group of uplink U-plane ports 750. The K-th candidate beamId field indicates the beam identifier 1560 value associated with the K-th beamGroupId. The K-th beamId field indicates the beam identifier 1560 value associated with the K-th group of uplink U-plane ports 750.

According to ST-Y, the O-RU 720 uses diverse-beamforming and performs beamforming weight 1570 selection on the masked OFDM symbol indicated in ST-Y. In SE-Z2, the candidate beam identifier 1560 values for three groups of uplink U-plane ports 750 are configured. The number of uplink U-plane ports 750 is explicitly configured in SE-Z2. A beamGroupId associated with a set of beam identifier 1560 values is configured, and the O-RU 720 selects one identical beam identifier 1560 value associated with the beamGroupId for each port in a given group of uplink U-plane ports 750.

For each group of uplink U-plane ports 750, a beam group ID indicates a set of beam identifier 1560 values for the O-RU 720 to select, and the number of uplink U-plane ports 750 is explicitly configured. With respect to the configuration of candidate beam groups for diverse-beamforming, one alternative provides that the beamGroupId association to candidate beam identifier 1560 values is configured through M-plane file transfer. In another alternative, the beamGroupId association to candidate beam identifier 1560 values is configured through C-plane, for example, through SE-Z2.

Although FIG. 15 illustrates one example of M-plane and C-plane signaling 1500 diverse-beamforming configuration using ST-Y and SE-Z2 for multiple uplink U-plane ports, various changes may be made to FIG. 15. For example, various components of FIG. 15 could be combined, further subdivided, or omitted and additional components could be added according to particular needs.

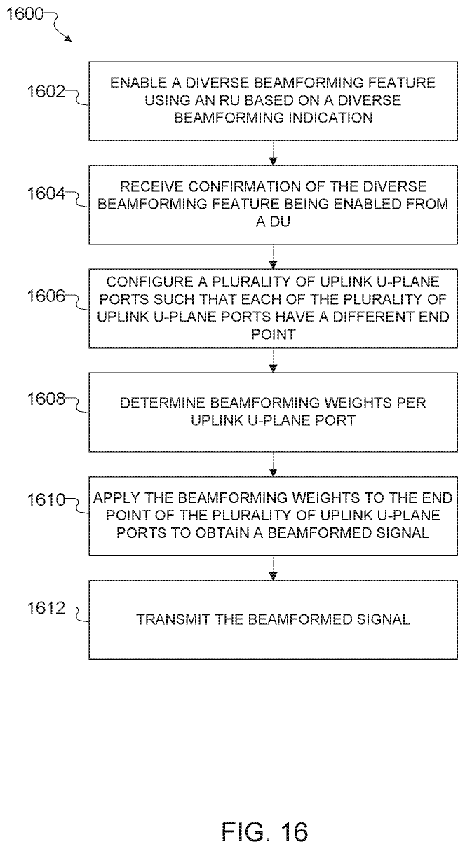

FIG. 16 illustrates an example method 1600 for O-RAN fronthaul signaling for uplink beamforming according to embodiments of the present disclosure. An embodiment of the method illustrated in FIG. 16 is for illustration only. One or more of the components illustrated in FIG. 16 may be implemented in specialized circuitry configured to perform the noted functions or one or more of the components may be implemented by one or more processors executing instructions to perform the noted functions. Other embodiments of for O-RAN fronthaul signaling for uplink beamforming could be used without departing from the scope of this disclosure.

As shown in FIG. 16, a diverse beamforming feature is enabled using an RU based on a diverse beamforming indication at step 1602. For example, the O-RU 720 may enable a diverse beamforming portion 650 during M-plane signaling with the O-DU 710. The beamforming feature may include one or more beamIDs where each of the one or more beamIDs identify a diverse beamforming configuration for the U-plane ports 750. The diverse beamforming indication may also include a dedicated section type, a dedicated section extension, an orthogonal frequency-division multiplexing (OFDM) symbol index, or a combination thereof.

Confirmation of the diverse beamforming feature being enabled is received at an RU from a DU at step 1604. For example, the O-RU 720 may receive confirmation of the diverse beamforming feature being enabled from the O-DU 710 during M-plane signaling.

A plurality of uplink U-plane ports are configured such that each of the plurality of uplink U-plane ports have a different end point at step 1606. For example, the O-RU 720 may configure the uplink U-plane ports 750 to have a different end point.

Beamforming weights are determined using the RU per uplink U-plane port at step 1608. For example, the O-RU 720 determines beamforming weights for each of the uplink U-plane ports 750. Determining the beamforming weights per uplink U-plane port 750 may include selecting one beam from an RU beam book. Additionally, or alternatively, determining the beamforming weights per uplink U-plane port 750 may include selecting one of the one or more sets of candidate beamforming weights for each uplink U-plane port 750 within a group, such that the uplink U-plane ports 750 are configured with the same end-points and the same antenna masks. Selecting one of the one or more sets of candidate beamforming weights for each uplink U-plane port 750 within a group may include selecting the one of the one or more sets of candidate beamforming weights indicated through a capability of a C-plane message for diverse beamforming with candidate selection.

The beamforming weights are applied using the RU to the end point of the plurality of uplink U-plane ports to obtain a beamformed signal at step 1610. For example, the O-RU 720 applies the beamforming weights to each of the uplink U-plane ports 750. Applying the beamforming weights to the end point of the plurality of uplink U-plane ports 750 to obtain the beamformed signal may include, for each uplink U-plane port 750 configured with a beamID of the one or more beamIDs, and the U-plane ports 750 are associated to different end-points, determining the beamforming weights independently to other uplink U-plane ports 750 using the RU. The beamformed signal is transmitted, for example, to the O-DU 710 at step 1612.

Although FIG. 16 illustrates one example method for O-RAN fronthaul signaling for uplink beamforming, various changes may be made to FIG. 16. For example, while shown as a series of steps, various steps in FIG. 16 could overlap, occur in parallel, occur in a different order, or occur any number of times.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
enabling a diverse beamforming feature using a radio unit (RU) based on a diverse beamforming indication, the beamforming feature including one or more beam identifiers (IDs);
receiving, at the RU, confirmation of the diverse beamforming feature being enabled from a distributed unit (DU);
configuring a plurality of uplink user plane (U-plane) ports such that each of the plurality of uplink U-plane ports having a different end point;
determining, using the RU, beamforming weights per uplink U-plane port;
applying, using the RU, the beamforming weights to the end point of the plurality of uplink U-plane ports to obtain a beamformed signal; and
transmitting, using the RU, the beamformed signal.

2. The method of claim 1, wherein determining, using the RU, the beamforming weights per uplink U-plane port comprises selecting one beam from an RU beam book.

3. The method of claim 1, wherein each of the one or more beamIDs identify a diverse beamforming configuration for the U-plane ports.

4. The method of claim 1, wherein applying, using the RU, the beamforming weights to the end point of the plurality of uplink U-plane ports to obtain the beamformed signal comprises, for each uplink U-plane port configured with a beamID of the one or more beamIDs, and the U-plane ports are associated to different end-points, determining the beamforming weights independently to other uplink U-plane ports using the RU.

5. The method of claim 1, wherein the diverse beamforming indication comprises a dedicated section type, a dedicated section extension, an orthogonal frequency-division multiplexing (OFDM) symbol index, or a combination thereof.

6. The method of claim 1, wherein the diverse beamforming indication comprises one or more sets of candidate beamforming weights; and
wherein determining, using the RU, the beamforming weights per uplink U-plane port comprises selecting one of the one or more sets of candidate beamforming weights for each uplink U-plane port within a group, such that the uplink U-plane ports are configured with the same end-points and the same antenna masks.

7. The method of claim 6, wherein selecting one of the one or more sets of candidate beamforming weights for each uplink U-plane port within a group comprises selecting the one of the one or more sets of candidate beamforming weights indicated through a capability of a C-plane message for diverse beamforming with candidate selection.

8. An electronic device, comprising:
a transceiver; and
a processor operably coupled to the transceiver, configured to cause the electronic device to:
enable a diverse beamforming feature based on a diverse beamforming indication, the beamforming feature including one or more beam identifiers (IDs);
receive confirmation of the diverse beamforming feature being enabled from a distributed unit (DU);
configure a plurality of uplink user plane (U-plane) ports such that each of the plurality of uplink U-plane ports has a different end point;
determine beamforming weights per uplink U-plane port;
apply the beamforming weights to the end point of the plurality of uplink U-plane ports to obtain a beamformed signal; and
transmit the beamformed signal.

9. The electronic device of claim 8, wherein the processor, when causing the electronic device to determine the beamforming weights per uplink U-plane port, is further configured to cause the electronic device to select one beam from an RU beam book.

10. The electronic device of claim 8, wherein each of the one or more beamIDs identify a diverse beamforming configuration for the U-plane ports.

11. The electronic device of claim 8, wherein the processor, when causing the electronic device to apply the beamforming weights to the end point of the plurality of uplink U-plane ports to obtain the beamformed signal, is further configured to cause the electronic device to:
for each uplink U-plane port configured with a beamID of the one or more beamIDs, and the U-plane ports are associated to different end-points, determine the beamforming weights independently to other uplink U-plane ports.

12. The electronic device of claim 8, wherein the diverse beamforming indication comprises a dedicated section type, a dedicated section extension, an orthogonal frequency-division multiplexing (OFDM) symbol index, or a combination thereof.

13. The electronic device of claim 8, wherein the diverse beamforming indication comprises one or more sets of candidate beamforming weights; and
wherein the processor, when causing the electronic device to determine the beamforming weights per uplink U-plane port, is further configured to cause the electronic device to select one of the one or more sets of candidate beamforming weights for each uplink U-plane port within a group, such that the uplink U-plane ports are configured with the same end-points and the same antenna masks.

14. The electronic device of claim 13, wherein the processor, when causing the electronic device to select one of the one or more sets of candidate beamforming weights for each uplink U-plane port within a group, is further configured to cause the electronic device to:
select the one of the one or more sets of candidate beamforming weights indicated through a capability of a C-plane message for diverse beamforming with candidate selection.

15. A non-transitory computer-readable medium comprising program code, that when executed by at least one processor of an electronic device, causes the electronic device to:
enable a diverse beamforming feature based on a diverse beamforming indication, the beamforming feature including one or more beamIDs;
receive confirmation of the diverse beamforming feature being enabled from a DU;
configure a plurality of uplink user plane (U-plane) ports such that each of the plurality of uplink U-plane ports having a different end point;
determine beamforming weights per uplink U-plane port;
apply the beamforming weights to the end point of the plurality of uplink U-plane ports to obtain a beamformed signal; and
transmit the beamformed signal.

16. The non-transitory computer-readable medium of claim 15, wherein the program code, that when executed by the at least one processor, causes the electronic device to determine the beamforming weights per uplink U-plane port, further comprises program code, that when executed by the at least one processor, causes the electronic device to select one beam from an RU beam book.

17. The non-transitory computer-readable medium of claim 15, wherein each of the one or more beamIDs identify a diverse beamforming configuration for the U-plane ports.

18. The non-transitory computer-readable medium of claim 15, wherein the program code, that when executed by the at least one processor, causes the electronic device to apply the beamforming weights to the end point of the plurality of uplink U-plane ports to obtain the beamformed signal, further comprises program code, that when executed by the at least one processor, causes the electronic device to:
for each uplink U-plane port configured with a beamID of the one or more beamIDs, and the U-plane ports are associated to different end-points, determine the beamforming weights independently to other uplink U-plane ports.

19. The non-transitory computer-readable medium of claim 15, wherein the diverse beamforming indication comprises a dedicated section type, a dedicated section extension, an orthogonal frequency-division multiplexing (OFDM) symbol index, or a combination thereof.

20. The non-transitory computer-readable medium of claim 15, wherein the diverse beamforming indication comprises one or more sets of candidate beamforming weights; and
wherein the program code, that when executed by the at least one processor, causes the electronic device to determine the beamforming weights per uplink U-plane port, further comprises program code, that when executed by the at least one processor, causes the electronic device to select one of the one or more sets of candidate beamforming weights for each uplink U-plane port within a group, such that the uplink U-plane ports are configured with the same end-points and the same antenna masks.
